(19) United States
(12) Patent Application Publication
(10) Pub. No.: US 2021/0337992 A1
(43) Pub. Date: Nov. 4, 2021

(54) SOUND-EMITTING DRINKING DEVICE

(71) Applicant: JPI-KITSAP, LLC, BAINBRIDGE IS, WA (US)

(72) Inventor: Sanjay Mahtani, Kowloon (HK)

(21) Appl. No.: 17/305,810

(22) Filed: Jul. 14, 2021

Related U.S. Application Data
(63) Continuation of application No. PCT/US2020/070753, filed on Nov. 5, 2020.
(60) Provisional application No. 62/930,832, filed on Nov. 5, 2019.
(60) Provisional application No. 62/930,839, filed on Nov. 5, 2019.

(51) Int. Cl. A47G 19/22

(52) U.S. Cl. CPC A47G 19/2227; A47G 2019/2244; A47G 2019/2238

(57) ABSTRACT

Disclosed herein is a sound-emitting drinking device. A sound-emitting drinking device may comprise functionality of playing audio such as music, vocal snippets, or other sounds upon a user's drinking from the device. Such a system may provide benefits in engagement, enjoyment, and entertainment in users upon drinking through the device.

### CROSS REFERENCE TO RELATED APPLICATIONS

This application is a continuation application of, and claims the benefit of priority under 35 U.S.C. § 120 to PCT Application PCT/US2020/070753, filed Nov. 5, 2020, which claims the benefit of priority under 35 U.S.C. § 119 to U.S. Provisional Patent Application Ser. Nos. 62/930,832 and 62/930,839, both filed Nov. 5, 2019, which are incorporated herein by reference in their entirety.

### FIELD OF DISCLOSURE

The present disclosure relates to a sound-emitting drinking device. More specifically, various embodiments of the present disclosure relate to devices and systems that may play sounds when a user engages various features of the device.

### BACKGROUND

The “sippy cup” is a drinking device, commonly featuring a lid with a drinking feature such as a spout or straw, which provides a self-contained, spill-preventive vessel for beverages such as water, juice, or milk. Sippy cups may used by toddlers as they transition away from vessels like baby bottles, as well as by children and adults. Beyond its utilitarian functionality, the common sippy cup may be limited in its ability to engage the user. It may be advantageous—e.g. in entertaining the user, encouraging hydration, etc.—for a sippy cup to have sound-emitting functionality that is responsive to user actions such as drinking. In view of at least the above, a need exists for a sound-emitting drinking device.

### SUMMARY

In accordance with the present disclosure, in various embodiments, the disclosed device may emit sound upon a user's engagement of a drinking feature such as a straw or “sippy spout.” Examples described herein include sound-emitting drinking devices that may provide audio playback upon engagement of a drinking feature. The disclosed device comprise an audio module that may be equipped with sound-emitting and sensing elements that may detect the passage of liquid. As an illustrative example, a sippy cup may have a small speaker that is configured to play pre-recorded audio content, such as an animal sound or a vocal snippet, upon the sensor's detection of liquid passing through the drinking feature. The device may feature a power source (e.g. a battery, supercapacitor, solar cell, wireless powering or charging element), a sound-emitting component (e.g. a diaphragm or piezoelectric speaker), a sensor element for sensing the passing of liquid, and one or more hardware and/or software modules for managing sensing and playback.

An objective of the disclosed device may be to emit sound upon a user's drinking liquid through the device.

Another objective of the disclosed device may be to trigger audio content upon a user's drinking liquid through the device, wherein the triggered audio content may be “continuous” (i.e. play while and as long as the device detects liquid being drawn) or “one-shot” (i.e. play once upon detecting liquid being drawn, and again upon subsequent such detections).

Another objective of the disclosed device may be to play different audio content upon drinking, based upon a state of liquid in the device (e.g. stating “I'm half full” when approximately half full) or a state of drinking (e.g. growing louder upon stronger suction).

Another objective of the disclosed device may be to enable a user to record their own audio content to be played back by the device upon drinking.

Another objective of the disclosed device may be to accompany playback of visual content (e.g. LED light, color changing light, embedded screen, e-paper) upon a drinking.

Another objective of the disclosed device may be to provide for different visual responses to a users' drinking liquid through the device, based upon a factor external to the device such as ambient light or temperature, time, or proximity to another device.

Another objective of the disclosed device may be to play sounds, music, or vocal content associated with recognizable animals, characters, or brands upon drinking.

Another objective of the disclosed device may be to visually present recognizable characters, animals, or objects and to play sounds, music, or vocal content associated with such recognizable characters, animals, or objects.

Another objective of the disclosed device may be to interface with a device (i.e. a controller) or a software interface (i.e. a smartphone app) to control or interact with audio, visual, or other features of the device.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the Applicants. The Applicants retain and reserve all rights in their trademarks and copyrights included herein, and grant permission to reproduce the material only in connection with reproduction of the granted patent and for no other purpose.

Furthermore, the drawings and their brief descriptions below may contain text or captions that may explain certain embodiments of the present disclosure. This text is included for illustrative, non-limiting, explanatory purposes of certain embodiments detailed in the present disclosure. In the drawings:

FIG. 1 illustrates an exploded view of a sound-emitting drinking device consistent with various embodiments of the present disclosure.

FIG. 2 illustrates an exploded view of a sound module of a sound-emitting drinking device consistent with various embodiments of the present disclosure.

FIGS. 3-4 illustrate top and bottom perspective views of a sound module of a sound-emitting drinking device consistent with various embodiments of the present disclosure.

FIGS. 5-8 illustrate perspective, top, front, and side views of an example sound-emitting drinking device consistent with various embodiments of the present disclosure.

FIG. 9-12 illustrate perspective, top, front, and side views of another example sound-emitting drinking device consistent with various embodiments of the present disclosure.

FIG. 13 illustrates a method for utilizing a sound-emitting drinking device consistent with various embodiments of the present disclosure.

FIG. 14 illustrates a computing platform for a sound-emitting drinking device and programming system in accordance with various embodiments of the present disclosure.

### DETAILED DESCRIPTION

As a preliminary matter, it will readily be understood by one having ordinary skill in the relevant art that the present disclosure has broad utility and application. As should be understood, any embodiment may incorporate only one or a plurality of the disclosed aspects of the disclosure and may further incorporate only one or a plurality of the disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of stages of various processes or methods that are described herein are illustrative and not restrictive. Accordingly, it should be understood that, although stages of various processes or methods may be shown and described as being in a sequence or temporal order, the stages of any such processes or methods are not limited to being carried out in any particular sequence or order, absent an indication otherwise. Indeed, the stages in such processes or methods generally may be carried out in various different sequences and orders while still falling within the scope of the present disclosure. Accordingly, it is intended that the scope of patent protection be defined by the issued claim(s).

Regarding applicability of 35 U.S.C. § 112, ¶6, no claim element is intended to be read in accordance with this statutory provision unless the explicit phrase “means for” or “stage for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in, the context of, embodiments of the present disclosure are not limited to use only in this context.

### I. OVERVIEW

Consistent with embodiments of the present disclosure, a sound-emitting drinking device (or simply “device”) 100 is provided. Some or all of the following components may be present in system 100. The below description is in no way intended to limit the components that may be present in addition or in alternative to the listed components, nor to require that any particular component be included in a form described below or at all.

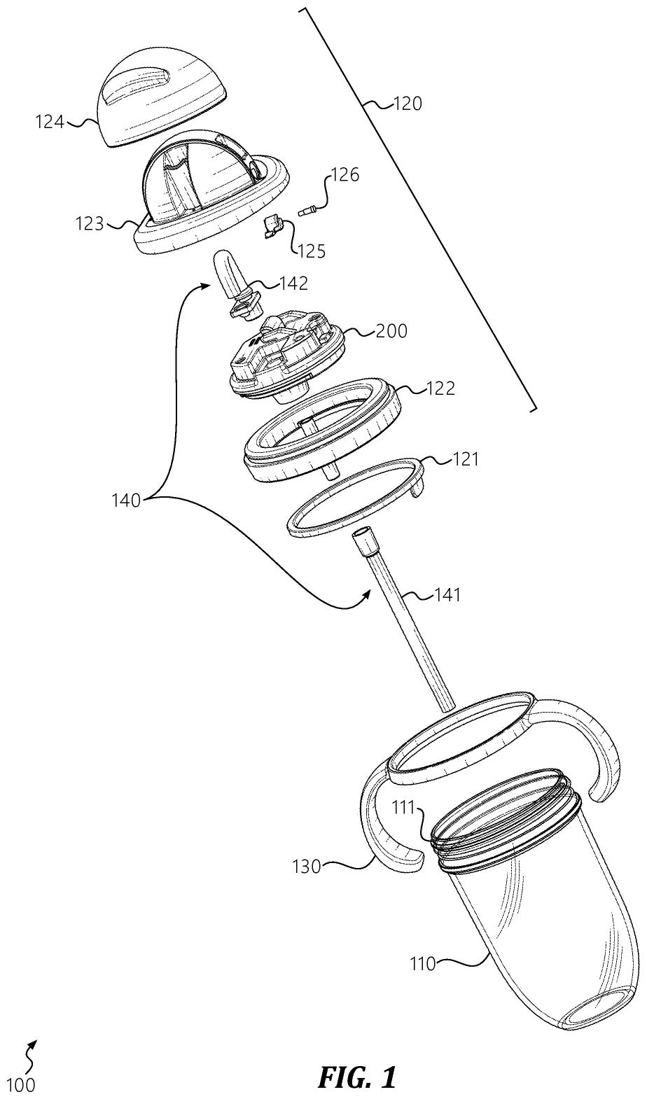

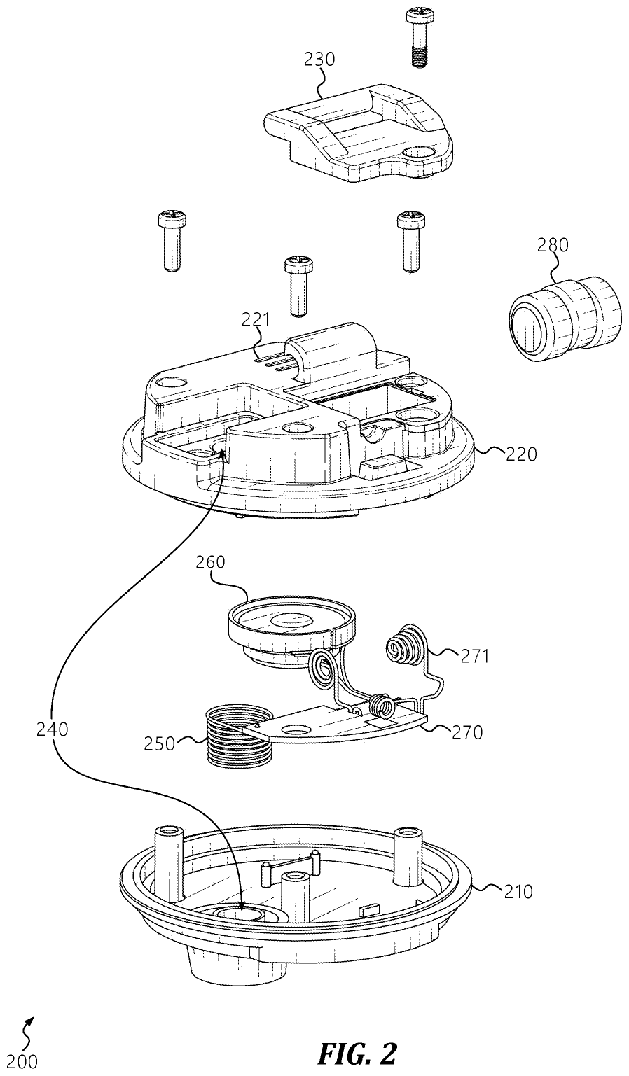

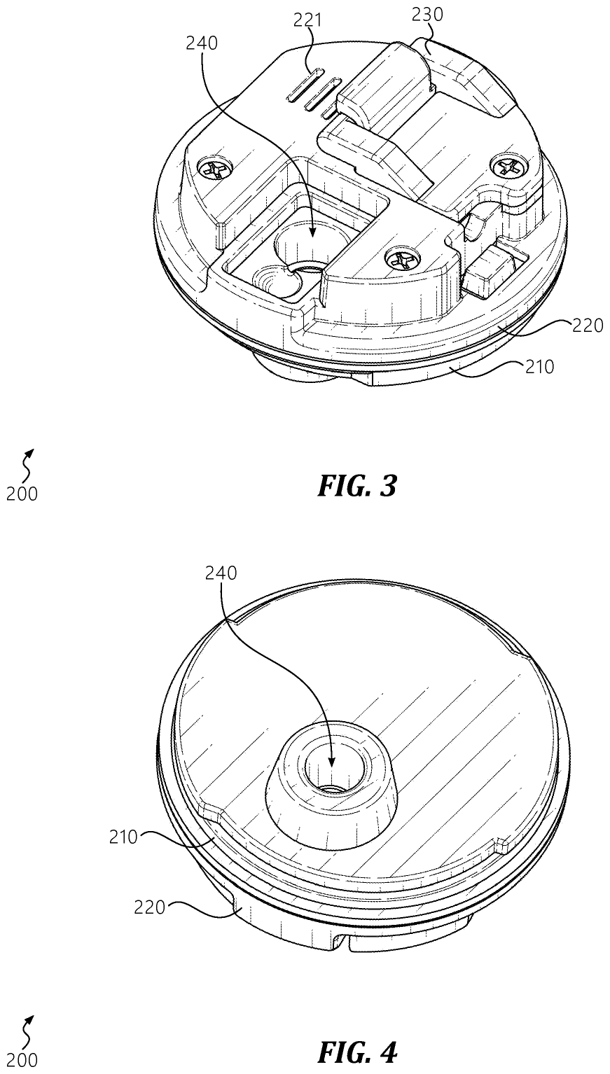

Referring now to FIGS. 1-2, there is shown an example sound-emitting drinking device 100 consistent with various embodiments of the present disclosure. Device 100 may deliver audio content upon the passage of liquid through a drinking feature 140. A drinking feature 140 may be, or comprise, drinking elements such as straws, tubes, and spouts, such as spout 142 and interior tube 141. When sensor 250 senses the passage of liquid through drinking feature 140, it may signal an audio unit 270 to play a sound through a sound-emitting element 260 (e.g. a speaker). In various embodiments, multiple components may be housed together, for example, as lid assembly 120 as depicted in FIG. 1 or sound module 200 as depicted in FIG. 2.

Device 100 may deliver various kinds of audio in a variety of embodiments, including audio that is entertaining, educational, motivational, informational, soothing, etc. While some embodiments may be suited to toddlers and young children, various other embodiments may be suited to older children, adults, or all ages. For example, an embodiment comprising a children's sippy cup may play an engaging sound effect upon drinking. In one example, sound played back upon sensing of fluid passage may mimic a character, animal, or object embodied in device 100 (e.g. elements such as lid assembly 120 and cup 110 may be stylized like a lion, dinosaur, or superhero). For example, a cow-styled device 100 may moo, whereas an device 100 featuring an anthropomorphized star may sing “Twinkle Twinkle Little Star”. In some embodiments, more than one audio response may be possible, as on a fixed loop of snippets to play back, or more subtly responsive, as in embodiments featuring appropriate volume/flow rate sensors (“Oh my, that was a big sip!”). In some embodiments, a user may be able to record their own audio to audio unit 270 for playback upon drinking.

In another example, device 100 may play ocean sounds upon the user's drinking through drinking feature 140 (and may be appropriately beach-stylized). In still another example, device 100 may be configured to deliver a motivational message upon drinking, such as “keep going!” or “you've got this!”, which may be suited to a workout context. In embodiments featuring appropriate sensors, device 100 may tell the user how much total volume has been consumed in over a time period (“That's 16 ounces today!”), which could be triggered every sip or only at certain thresholds (e.g. every 300 ml). In embodiments featuring appropriate sensors and/or communication elements (e.g. Bluetooth), device 100 may be configured to tell the user information upon drinking, such as step count or number of unread emails, gleaned from device 100 itself or from another device in communication therewith (e.g. a smartwatch).

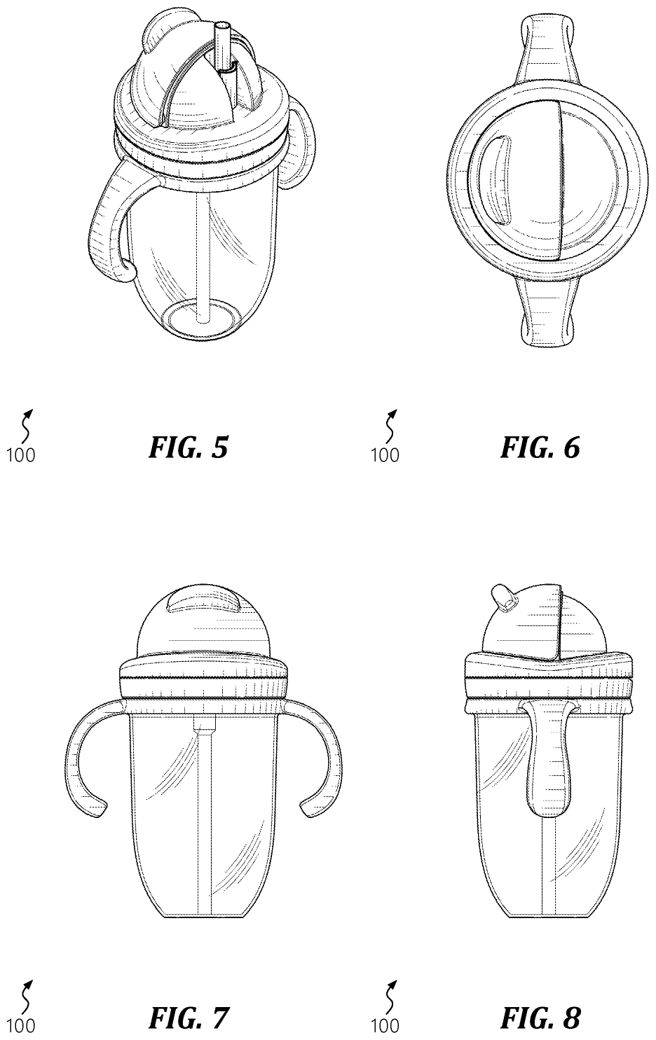

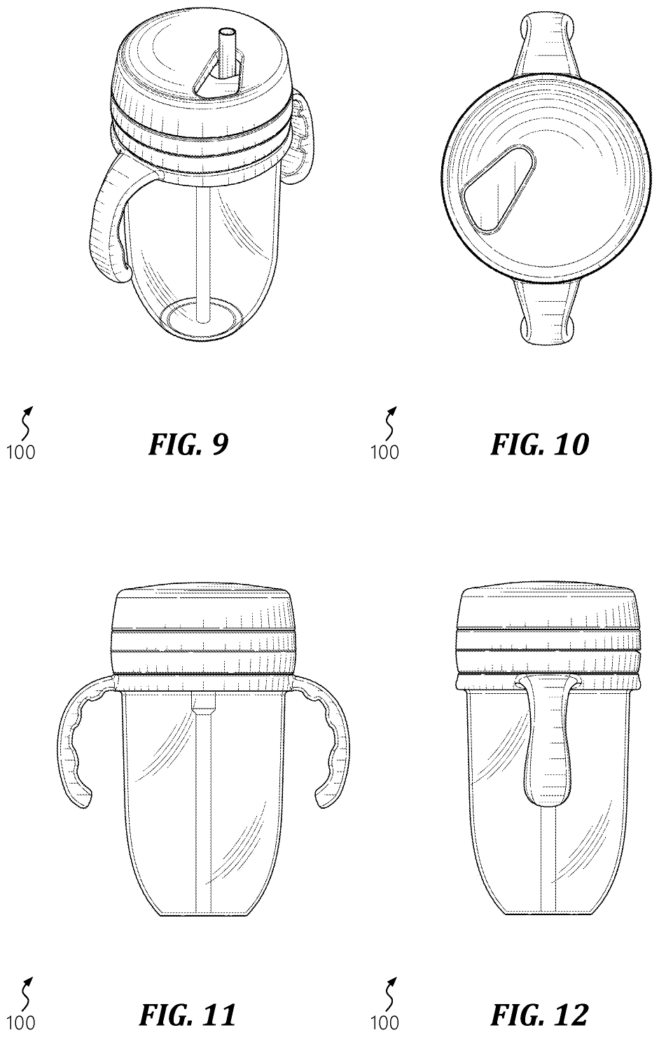

Various embodiments, may comprise a sealing mechanism wherein a sliding, pivoting, retracting, plugging, or twisting mechanism may transition device 100 between a sealed state and a drinking state, respectively preventing or allowing the egress of the contents of cup 110 through drinking feature 140. An example embodiment, consistent with device 100 as depicted in FIGS. 1 and 5-8, may comprise a lid assembly 120 that may pivot open or shut (a “flip top” or a “flip lid”). As an example consistent with such an embodiment, lid assembly 120 may comprise a lid cover 124 that may slide with respect to the top of device 100 to transition between sealed and drinking states. Another example embodiment, consistent with device 100 as depicted in FIGS. 9-12, may comprise a lid assembly 120 that may twist open or shut (a “twist top” or “twist lid”). Consistent with such an embodiment, a lid cover 124 may twist with respect to the top of device 100 to transition between sealed and drinking states. Various embodiments may comprise lid assemblies 120 that may comprise a flip top, a twist top, and other mechanisms that, e.g., slide, pivot, retract, plug, twist, or otherwise transition to a sealed or closed state. Drinking feature 140 may retract, flexibly collapse, detach, etc. to accommodate the motion of lid assembly 120 or a part thereof.

Device 100 may comprise various visual display elements that may be triggered by the passage of liquid through drinking feature 140. When sensor 250 detects drinking (or cessation) in drinking feature 140, a visual display element on lid assembly 120 or elsewhere in or on device 100 may be triggered, such as light-up eyes, strobing lights, illumination of shape, letter, number, or character features, or illumination of an element such as lid cover 124 or cup 110. Various embodiments of device 100 may comprise visual display elements such as static lighting elements, analog or digital displays, color- or transparency-changing features, holographic or lenticular features, and illuminable features (as may be, e.g., molded, cast, etched, additively manufactured, etc.). In some embodiments, sound and visual content may be synchronized to the sensing of liquid passage. In some embodiments, device 100 may comprise a temperature sensing element that may, upon detecting a temperature exceeding a safe consumption threshold, for example, trigger an indication by sound-emitting device 260 and/or a visual element, or transition device 100 into a sealed state (thereby preventing the egress of the unsafe liquid).

Device 100 may also comprise various mechanical controllers that may be triggered by the passage of liquid through drinking feature 140. In an example, a colorful ball may move along a track embedded in top housing 123 when the passage of liquid is sensed. In another example, a mechanical controller might cause device 100 to vibrate upon drinking.

Device 100 may have various mechanisms that control how or when device 100 functions. In various embodiments, audio module 200 may be configured such that when sensor 250 detects cessation of liquid passing through drinking feature 140, audio playback is stopped as well. In various embodiments, the lid assembly 120 may control certain aspects of the operation of device 100. For example, in some embodiments, when a sealing mechanism (e.g. a flip or twist top comprising a lid cover 124) transitions to a drinking state, device 100 may be powered on (e.g. by engaging power source 280), and conversely when the sealing mechanism transitions to a sealed state, device 100 may be powered off. In various embodiments, the transition between sealed and drinking states (for example, opening or closing a lid) may, e.g. trigger or stop sound playback, visual display actions, mechanical controller actions, or a variety of other device 100 functions.

Device 100 may comprise buttons that enable various functionality, such as volume up/down/off, change audio loop, play, replay, or silence audio, activate visual element, record user audio, illuminate drink (i.e. via light element on the bottom of a straw), etc.

Device 100 may comprise various form factors, including, but not limited to, a sippy cup, a cup with one or more straight, flexible, or collapsible straw components, a baby bottle, and a puncturative straw or screw-on drinking feature 140 for use with disposable or reusable pouches. In some embodiments, device 100 may comprise a warming or cooling element (generally, a “temperature modulating element”) that may be configurable to bring liquid in cup 110 to a desired temperature and maintain such temperature. In some embodiments, device 100 may comprise features such as a defoaming element (e.g. a mechanical defoaming system housed within cup 110), which may be helpful to, e.g., infants or very young children.

### II. COMPONENTS

Some or all of the following components may be present in a sound-emitting drinking device 100. The below description is in no way intended to limit the components that may be present in addition or in alternative to the listed components, nor to require that any particular component be included in a form described below or at all.

a. Cup 110

Device 100 may comprise a cup 110 for holding the liquid which is to be consumed via device 100. Cup 110 may comprise various elements such as a connecting element 111 (e.g. a screw thread), which may interact with an element of lid assembly 120 such as a seal ring 121.

b. Lid Assembly 120

Device 100 may comprise a lid assembly (or simply “lid”) 120. Lid 120 may provide various functions, such as comprising drinking feature 140 through which liquids in the device may be consumed, and preventing liquid from escaping cup 110 (e.g. by attaching or connecting therewith) other than by drinking through drinking feature 140.

In some embodiments, lid 120 may comprise, house, or incorporate various other features, such as a sealing mechanism (e.g. embodied in lid cover 124), sound module 200, and part or all of drinking feature 140 (such as spout 142). Lid 120 may incorporate one or more handles 130.

Lid assembly 120 may in fact be an assembly of subcomponents, or the elements thereof may be integral and/or monolithic with respect to lid 120. In an example embodiment consistent with FIG. 1, lid assembly 120 may comprise a seal ring 121, a bottom housing 122 that may interface with seal ring 121, top housing 123, and sound module 200, a lid cover 124 that may interface with top housing 123, and a trigger key 125 and lock pin 126 which may engage with the top housing 123 and lid cover 124.

In various embodiments, the act of manipulating lid 120 (i.e. opening, closing, twisting, lifting, etc.) may trigger the playback of audio (e.g. “Hi there, welcome back!”; “This liquid is thirty degrees centigrade”), a visual indication (e.g. blinking light; LED screen message), or another action by device 100 such as heating or cooling (as by a temperature modulating element) or defoaming (as by a defoaming element).

c. Handle 130

Device 100 may optionally comprise a handle 130, which may facilitate the grasping, lifting, manipulation, and drinking from device 100 by a user such as a small child. Handle 130, if present, may comprise or be functional in connecting, attaching, or sealing cup 110 to lid 120.

d. Drinking Feature 140

Device 100 may comprise a drinking feature 140, which may facilitate the drinking of liquid by a user from device 100. Drinking feature 140 may comprise a spout 142 and may, but need not, incorporate a straw element 141 that may be disposed, for example, within cup 110. In an example, an interior tube 141 and a spout 142 (e.g. through a through hole 240 in sound module 200) may interface with a bottom housing 122, altogether forming drinking feature 140.

e. Sound Module 200

Device 100 may comprise a sound module 200, which may facilitate sensing and sound-emitting capabilities. Sound module 200 may comprise various components, such as power source 280, audio unit 270, sound-emitting element 260, and sensor 250. In various embodiments, sound module 200 may have structural components such as a through hole 240 (which may allow drinking feature 140 to pass through sensor 250), a battery door 230 (which may hold power source 280 in place), top case 220 (which may comprise a speaker grille 221 disposed over sound-emitting element 260), and bottom case 210. Various components that sound module 200 may comprise or interface with are described in greater detail below.

f. Sensor 250

Device 100 may comprise a sensor 250, which may facilitate the detection of liquid passing through drinking feature 140. Sensor 250 may comprise capacitive, EM, acoustical, piezoelectric, or other types of sensors. In some embodiments, sensor 250 may be capable of determining additional detail about liquid that flows through drinking element 240, such volume, duration, presence of bubbles, or optical properties. In some embodiments, sensor 250 may comprise or combine with additional sensors of various physical, electrical, chemical, etc. properties.

g. Sound-Emitting Element 260

Device 100 may comprise a sound-emitting element (or “speaker”) 260, such as a piezoelectric, electrostatic, or diaphragm speaker, which may facilitate the emission of sound in response to drinking from device 100. Speaker 260 may comprise or be configured with a grill, grate, or protective material or structure. In some embodiments, speaker 260 (and/or other components) may be configured and materially constituted so as to be amenable to liquid immersion or cleaning in a dish washer.

In some embodiments, speaker 260 may be configured to play music, such as a soothing lullaby or a cartoon theme song. In some embodiments, a user may be able to indicate a selection amongst multiple audio responses to be played upon drawing liquid through device 100.

In some embodiments, sound-emitting element 260 may comprise, or may be accompanied by, a microphone or other listening element. Such an embodiment may facilitate responsive communications and/or “smart assistant”-like functionality whereby device 100 might, e.g., answer questions, respond to animal or character words/vocal triggers with corresponding animal noises or character sounds/catchphrases, or respond to caregiver questions as to temperature or sitting duration of liquid (i.e. “how long has this milk been sitting at room temperature”). In some embodiments comprising a listening element, audio unit 270 may be configured to process incoming audio signals, which may necessitate hardware and/or software solutions comprising DSP, AI, etc. Additionally or alternatively, audio processing may be performed by an external computing platform via a wireless communication connection.

h. Audio Unit 270

Device 100 may comprise an audio unit 270, which may facilitate the triggering of audio emission by speaker 260 in response to the detection of fluid passage by sensor 250. Audio unit 270 may comprise digital or analog audio processing hardware, and may be electronic or purely electrical in nature. In an example, audio unit 270 may comprise a printed circuit board (PCB). In various embodiments, audio unit 270 (and in some cases, device 100 generally) may be powered by making contact with power source 280 via power contact 271.

i. Power Source 280

Device 100 may comprise a power source 280, such as a battery, capacitive element, or solar panel, which may facilitate the operation of other elements that may require power; for example, in some embodiments, speaker 260, processor 270, and or sensor 250. In some embodiments, power source 280 may also power visual features such as LED lights or displays, or other components such as a wireless communication (i.e. Bluetooth) module. Some embodiments may be chargeable via a power cable over a standard such as USB.

### III. METHODS OF USE

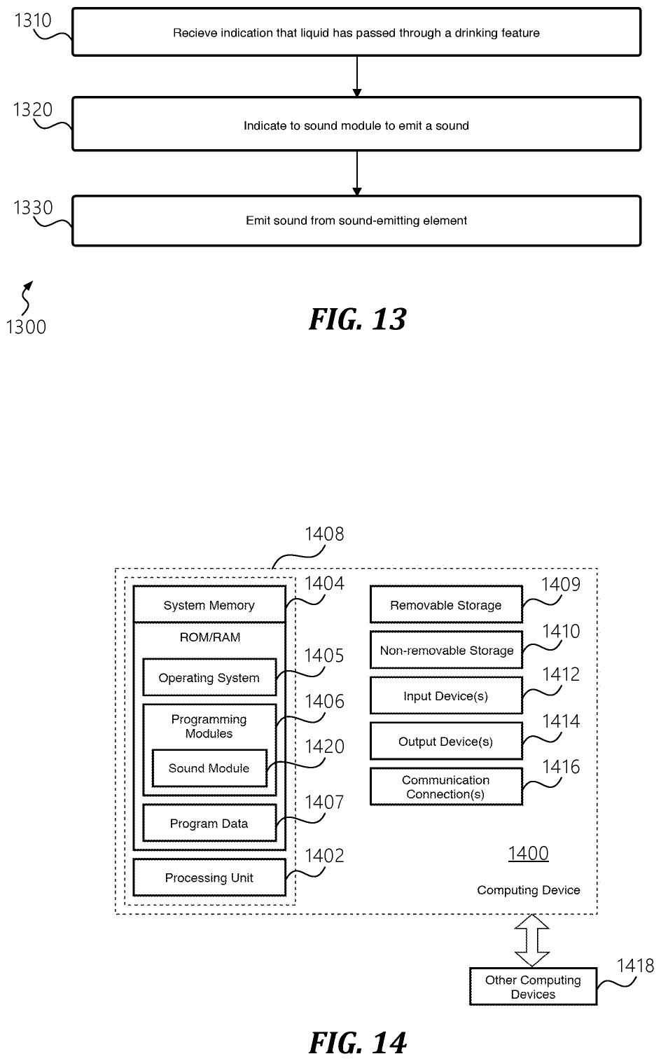

Referring now to FIG. 13, there is shown an example method 1300 for utilizing device 100 in accordance with an embodiment.

At stage 1310, an indication may be received from sensor 250 that liquid has passed through a drinking feature 140. This may occur, for example, when a user has created sufficient suction to suck liquid up from the cup 110 through drinking feature 140. In an embodiment comprising a lid assembly 120, this may occur when the user drinks through spout 142.

At stage 1320, an indication may be transmitted to a sound module (e.g. audio unit 270) to emit a sound in response to the sensed liquid flow from stage 1310. In some embodiments, such a sound may be stored in a memory unit of audio unit 270. At this stage, in embodiments comprising visual elements, an indication may also be transmitted to a visual, lighting, or video module, light controller, or light bank. In embodiments comprising mechanical/actuated elements, an indication may also be transmitted to a servo controller.

At stage 1330, a sound-emitting element 260 may, in accordance with the indication transmitted at stage 1320, emit a sound. In various embodiments, the sound may be stored in audio unit 270. In various embodiments, a user may able to first record a sound of their choosing or generation, and the sound that is emitted at this stage may be the sound so chosen or generated by the user. At this stage, in embodiments comprising visual elements, the appropriate element may light up, flash, change colors, light in a pattern, display text, etc. In embodiments comprising mechanical/actuated elements, the appropriate element may move in the prescribed manner.

In an example consistent with an embodiment, a device 100 featuring colorful shapes may, upon drinking through drinking feature 140, light up the shapes in a colorful pattern. In another example, a device 100 featuring an element on an enclosed track may, upon drinking through drinking feature 140, move the element along the enclosed track.

The order of stages presented are only illustrative of the possibilities and those steps can be executed or performed in any suitable fashion. Moreover, the various features of the examples described here are not mutually exclusive. Rather any feature of any example described here can be incorporated into any other suitable example. It is intended that the specification and examples be considered as exemplary only.

### IV. PLATFORM ARCHITECTURE

Embodiments of system 100 may comprise aspects including, but not limited to, mobile software applications (or “apps”), websites, web applications, desktop software, server software, embedded software, microcontrollers, databases, wired and wireless networking hardware and software, and various computing devices. Moreover, system 100 or aspects thereof may be hosted one or more physical or virtual servers, cloud computing services, blockchain platforms, or distributed computing platforms. Alternatively, or in addition, system 100 may be implemented in one or more of a plurality of mobile devices.

Although methods disclosed herein have been described to be performed by a computing device 1400, it should be understood that, in some embodiments, different operations may be performed by different networked elements in operative communication with computing device 1400. Computing device 1400 may comprise, but not be limited to, a desktop computer, a laptop, a server, an ASIC, a touchscreen, a tablet, or a mobile telecommunications device.

Embodiments of the present disclosure may comprise a system having a memory storage and a processing unit. The processing unit coupled to the memory storage, wherein the processing unit is configured to perform the stages of methods disclosed herein.

FIG. 14 is a block diagram of a system including computing device 1400. Consistent with an embodiment of the disclosure, the aforementioned memory storage and processing unit may be implemented in a computing device, such as computing device 1400 of FIG. 14. Any suitable combination of hardware, software, or firmware may be used to implement the memory storage and processing unit. For example, the memory storage and processing unit may be implemented with computing device 1400 or any of other computing devices 1418, in combination with computing device 1400. The aforementioned system, device, and processors are examples and other systems, devices, and processors may comprise the aforementioned memory storage and processing unit, consistent with embodiments of the disclosure.

With reference to FIG. 14, a system consistent with an embodiment of the disclosure may include a computing device, such as computing device 1400. In a basic configuration, computing device 1400 may include at least one processing unit 1402 and a system memory 1404. Depending on the configuration and type of computing device, system memory 1404 may comprise, but is not limited to, volatile (e.g. random access memory (RAM)), non-volatile (e.g. read-only memory (ROM)), flash memory, or any combination. System memory 1404 may include operating system 1405, one or more programming modules 1406 (including, for example, sound module 1420), and may include a program data 1407. Operating system 1405, for example, may be suitable for controlling the operation of computing device 1400. Features of programming modules 1406 may include formatting and displaying information to the user, and formulating and transmitting programming instructions. Furthermore, embodiments of the disclosure may be practiced in conjunction with a graphics library, other operating systems, or any other application program and is not limited to any particular application or system. This basic configuration is illustrated in FIG. 14 by those components within a dashed line 1408.

Computing device 1400 may have additional features or functionality. For example, computing device 1400 may also include additional data storage devices (removable and/or non-removable) such as, for example, magnetic disks, optical disks, or tape. Such additional storage is illustrated in FIG. 14 by a removable storage 1409 and a non-removable storage 1410. Computer storage media may include volatile and nonvolatile, removable and non-removable media implemented in any method or technology for storage of information, such as computer readable instructions, data structures, program modules, or other data. System memory 1404, removable storage 1409, and non-removable storage 1410 are all computer storage media examples (i.e., memory storage.). Computer storage media may include, but is not limited to, RAM, ROM, EEPROM, flash memory or other memory technology, CD-ROM, DVD, or other optical storage, magnetic tape, magnetic disk storage, or other magnetic storage devices, or any other medium which can be used to store information and which can be accessed by computing device 1400. Any such computer storage media may be part of device 1400. Computing device 1400 may also have input device(s) 1412 such as a keyboard, mouse, pen, sound input device, touch input device, camera, sensor, etc. Output device(s) 1414 such as a display, speakers, printer, etc. may also be included. The aforementioned devices are examples and others may be used.

Computing device 1400 may also contain a communication connection 1416 that may allow device 1400 to communicate with other computing devices 1418, such as over a network in a distributed computing environment, for example, an intranet or the Internet. Communication connection 1416 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of programming modules 1406 and data files may be stored in system memory 1404, including operating system 1405. While executing on processing unit 1402, programming modules 1406 may perform processes including, for example, one or more of method stages as described above. The aforementioned process is an example, and processing unit 1402 may perform other processes. Other programming modules 1406 that may be used in accordance with embodiments of the present disclosure may include mobile device applications, data visualization applications, audio parameter control applications, authentication applications, network communications, database applications, etc.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, multiprocessor systems, microprocessor-based or programmable consumer electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a vehicle data bus, a portable computer diskette, a random access memory (RAM), a read-only memory (ROM), an erasable programmable read-only memory (EPROM or Flash memory), an optical fiber, and a portable compact disc read-only memory (CD-ROM).

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

### V. CLAIMS

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

The following is claimed:

1. A sound-emitting drinking device comprising:
a lid assembly;
a drinking feature;
a power source;
a sensor; and
a sound-emitting element,
wherein:
the sensor is configured to detect passage of liquid through the drinking feature,
the sound-emitting element is configured to emit sound upon the detection by the sensor of the passage of liquid through the drinking feature,
the lid assembly is configured to transition between a sealed state and a drinking state via a sealing mechanism comprising at least one of a flip top and a twist top,
utilizing the sealing mechanism to transition to the drinking state performs at least one of engaging a power source and providing an indication to power on the sound-emitting drinking device, and
utilizing the sealing mechanism to transition to the sealed state performs at least one of disengaging a power source and providing an indication to power off the sound-emitting drinking device.

2. The sound-emitting drinking device of claim 1, wherein the sound-emitting element is further configured to stop emitting sound upon the detection by the sensor of the cessation of liquid passing through the drinking feature.

3. The sound-emitting drinking device of claim 2, wherein the sound-emitting element, upon the detection by the sensor of the passage of liquid through the drinking feature, following the detection by the sensor of the cessation of liquid passing through the drinking feature, is configured to emit sound continuous from the point that the sound-emitting element last stopped emitting sound.

4. The sound-emitting drinking device of claim 1, further comprising a visual display element configured to perform at least one of emitting light, displaying a pattern, discontinuing emitting light, and discontinuing displaying a pattern upon the detection by the sensor of at least one of passage of liquid through the drinking feature and cessation of cessation of liquid passing through the drinking feature.

5. The sound-emitting drinking device of claim 1, further comprising a mechanical controller configured to move an element of the sound-emitting drinking device upon the detection by the sensor of at least one of passage of liquid through the drinking feature and cessation of cessation of liquid passing through the drinking feature.

6. The sound-emitting drinking device of claim 1, further wherein utilizing the sealing mechanism to transition to the drinking state provides an indication to perform an action by at least one of the sound-emitting element, a visual display element, a mechanical controller, and a communication module.

7. The sound-emitting drinking device of claim 1, further wherein utilizing the sealing mechanism to transition to the sealed state provides an indication to perform an action by at least one of the sound-emitting element, a visual display element, a mechanical controller, and a communication module.

8. The sound-emitting drinking device of claim 1, further configured to detect, via at least one of the sensor and an additional sensor, the total volume of liquid that has passed through the drinking feature over a period of time.

9. A drinking device for emitting sounds comprising:
a lid assembly comprising:
a drinking feature;
a sealing mechanism comprising at least one of:
a flip top; and
a twist top; and
a sound module comprising:
a sensor;
a sound-emitting element; and
a power source,
wherein:
the sealing mechanism is configured to transition the drinking feature between a sealed state and a drinking state,
the sealed state corresponds to a powered-off state for the drinking device, the drinking state further corresponds to a powered-on state for the drinking device,
the sound module is configured to emit sound upon the detection by the sensor of the passage of liquid through the drinking feature.

10. The drinking device of claim 9, wherein the sound module is further configured to stop emitting sound upon the detection by the sensor of the cessation of liquid passing through the drinking feature.

11. The drinking device of claim 9, further comprising a visual display element configured to perform at least one of emitting light, displaying a pattern, discontinuing emitting light, and discontinuing displaying a pattern upon the detection by the sensor of at least one of passage of liquid through the drinking feature and cessation of cessation of liquid passing through the drinking feature.

12. The drinking device of claim 9, further comprising a mechanical controller configured to move an element of the sound-emitting drinking device upon the detection by the sensor of at least one of passage of liquid through the drinking feature and cessation of cessation of liquid passing through the drinking feature.

13. The drinking device of claim 9, further wherein utilizing the sealing mechanism to transition the drinking feature between the sealed state and the drinking state provides an indication to perform an action by at least one of the sound module, a visual display element, and a mechanical controller.

14. A method of utilizing a sound-emitting drinking device comprising:
transitioning, via a sealing mechanism, to a drinking state;
sensing, by a sensor, the passage of liquid through a drinking feature;
indicating, to a sound emitting element, to emit a sound;
emitting, by the sound emitting element, a sound; and
transitioning, via the sealing mechanism, to a sealed state,
wherein:
the transitioning to a drinking state comprises at least one of engaging a power source and providing an indication to power on the sound-emitting drinking device, and
the transitioning to a sealed state comprises at least one of disengaging a power source and providing an indication to power off the sound-emitting drinking device.

15. The method of claim 14, further comprising:
sensing, by the sensor, the cessation of liquid passing through the drinking feature; and
indicating, to the sound-emitting element, to stop emitting sound.

16. The method of claim 15, further comprising:
sensing, by the sensor, the passage of liquid through a drinking feature subsequent to the sensing the cessation of liquid passing through the drinking feature; and
indicating, to the sound-emitting element, to emit a sound continuous from the point that the sound-emitting element last stopped emitting sound.

17. The method of claim 14, further comprising indicating, to a visual display element, to perform at least one of emitting light, displaying a pattern, discontinuing emitting light, and discontinuing displaying a pattern, upon the sensing, by the sensor, of at least one of the passage of liquid through the drinking feature and the cessation of liquid passing through the drinking feature.

18. The method of claim 14, further comprising indicating, to a mechanical controller, to move an element of the sound-emitting drinking device, upon the sensing, by the sensor, of at least one of the passage of liquid through the drinking feature and the cessation of liquid passing through the drinking feature.

19. The method of claim 14, wherein the transitioning to a drinking state further comprises providing an indication to perform an action by at least one of the sound-emitting element, a visual display element, a mechanical controller, and a communication module.

20. The method of claim 14, wherein the transitioning to a sealed state further comprises providing an indication to perform an action by at least one of the sound-emitting element, a visual display element, a mechanical controller, and a communication module.
